(19) United States
(12) Patent Application Publication
(10) Pub. No.: US 2011/0079734 A1
(43) Pub. Date: Apr. 7, 2011

(54) Elemental Analysis Based on Complementary Techniques

(76) Inventors: Lee GRODZINS, Lexington, MA (US); William L. Adams, Powell, OH (US); Paul Estabrooks, Monson, MA (US)

(21) Appl. No.: 12/895,655

(22) Filed: Sep. 30, 2010

Related U.S. Application Data
(60) Provisional application No. 61/248,187, filed on Oct. 2, 2009.

(51) Int. Cl. G01N 21/64; G01N 23/223

(52) U.S. Cl. 250/461.1; 378/45

(57) ABSTRACT

Methods and apparatus for analyzing a test sample using complementary techniques, such as x-ray fluorescence (XRF) and optical emission spectroscopy (OES), are disclosed for registering two or more test instruments, in relation to the test sample, such that each of the instruments analyzes substantially the same region as is analyzed by the other instrument(s), and for communicating analytical results between or among the instruments, or between the instruments and another component, to enable one or more of the instruments, or the other component, to combine the results and, thereby, more completely and accurately determine the composition of the test sample. Such registration and communication enables, for example, separate XRF and OES instruments to collectively determine the composition of the test sample, including the absolute amounts of light and heavy elements in the test material.

### CROSS-REFERENCE TO RELATED APPLICATION

This application claims the priority benefit under 35 U.S.C. §119(e) of U.S. provisional patent application Ser. No. 61/248,187, filed Oct. 2, 2009 and entitled “Elemental Analysis Based on Complementary Techniques”, the disclosure of which is incorporated herein by reference.

### TECHNICAL FIELD

The present invention relates to devices for determining composition of a test material and, more specifically, devices that use multiple techniques for determining the composition.

### BACKGROUND ART

X-ray fluorescence (“XRF”) is one method for quantifying the elemental composition of materials, but as a sought-for element gets lighter, XRF becomes less sensitive. As a general rule, XRF is useful for elements heavier than about titanium. In special cases, XRF is effective for measuring the fractional weight of lighter elements. For example, sulfur in oil is easily quantified. However, the method ceases to have any quantitative value for carbon, oxygen, fluorine and sodium and other very light elements.

A typical XRF analytical instrument includes an x-ray or gamma ray source for exciting a portion of a sample. An x-ray detector detects x-ray fluorescence from the excited portion of the sample. Signals from the detector are amplified and filtered. A processor analyses the distribution of pulse strengths in the signals to determine the composition of the sample. A hand-held XRF analyzer is described in U.S. Provisional Patent Application No. 60/889,465, titled “Small Spot X-Ray Fluorescence (XRF) Analyzer,” the contents of which are incorporated herein by reference.

To give a useful measure of light elements, the preferred in situ analysis method is optical emission spectroscopy (“OES”). OES is a known technique for determining elemental and chemical compositions. OES involves exciting a portion of a sample and spectroscopically analyzing optical (typically visible through ultraviolet) emissions resulting from the excitation. For example, an optical emission may be spectrally dispersed by a diffraction grating, the resulting spectrum (or a portion thereof) may be sensed by a set of optical detectors, and signals from the detectors may be processed to identify lines in the spectra caused by elements or molecules in the sample. Many portable OES systems currently available for measuring the elemental composition of alloys use spark discharges to excite the optical spectra to be analyzed. A hand-held OES analyzer is described in U.S. Provisional Patent Application No. 60/891,408, titled “Hand-Held, Self-Contained Optical Emission Spectroscopy (OES) Analyzer,” the contents of which are incorporated herein by reference

In recent years, lasers have been used to induce plasmas that result in visible and ultra-violet optical spectra. Variations of the basic technique involve different lasers and different spectrometers. The formed plasma may be of millimeter or micron size and the optical spectra may be viewed over microseconds or time-resolved in nanoseconds. The general technique is often referred to as laser-induced breakdown spectroscopy (“LIBS”), although sometimes it is referred to as laser-induced photon spectroscopy (“LIPS”). New lasers and new modalities are regularly being developed so that a new acronym LIPF (for “laser induced photon fluorescence”) is more appropriate. LIPF applies to any laser method for inducing photon spectra, from the infrared into the ultra-violet, that results in the identification of the elements or compounds in a sample matrix.

For more information regarding LIPF, see Romero et al., “Surface and tomographic distribution of carbon impurities in photonic-grade silicon using laser-induced breakdown spectrometry,” Journal of Analytical Atomic Spectrometry, Vol. 13, June 1998, the contents of which are incorporated herein by reference. See also Hwang, “A feasibility study of micro-laser induced breakdown spectroscopy applied to lead identification in metal alloys and environmental matrices,” Thesis (S.M.), Massachusetts Institute of Technology, indexed (OCoLC) 48198136 (1998), the contents of which are incorporated herein by reference. Spark-excited and laser-excited analytical techniques are collectively referred to herein as OES analysis.

In general, OES analysis yields data concerning relative concentrations of elements in a test sample, while XRF analysis yields absolute concentration data. However, XRF analysis generally cannot detect light elements. U.S. Pat. No. 6,801,595, titled “X-Ray Fluorescence Combined with Laser Induced Photon Spectroscopy,” the contents of which are incorporated herein by reference, discloses a device that includes a LIPF detector, an XRF detector and a processor that analyzes and combines signals from the optical and x-ray detectors to determine the composition of a test material. The volume of the sample measured by XRF overlaps with the volume of the sample measured by LIPF. Both detectors are sensitive to at least one common element, such as iron. The processor uses data from the optical detector and the x-ray detector about the common element to normalize data from the optical detector.

In use, first the common element is measured using one of the analytical techniques, such as XRF. For example, for a carbon steel target sample, iron may be measured first by the XRF detector. From the measurement, an absolute concentration of the first element is determined by the analysis processor. For example, iron might be measured, and a 60% concentration of iron might be found in the test sample.

A measurement is then taken using the other analytical technique, LIPF, where relative concentrations of second elements of the target sample are determined. The concentrations of the second elements are determined, relative to the first element. For example, the concentration of carbon in the sample may be found to be 1/100 (1%) as high as the concentration of iron in the sample.

The absolute concentration of the second element is determined from the absolute concentration of the first element and from the relative information regarding the first and second elements. For example, if iron is 60% of a steel alloy, and carbon is 1% of the iron concentration, then carbon is 0.6% of the test sample. This process is repeated for each of the second elements identified using the second analytical technique. For example, absolute concentration measurements for lighter elements, such as carbon and oxygen, may be determined using the absolute concentration information concerning the common element (here, iron) and the relative information between iron and carbon and between iron and oxygen.

Some users would prefer to use separate OES and XRF instruments for such analyses. However, using separate instruments poses registration and data coordination problems. If both instruments do not analyze nearly identical regions of a heterogeneous or matrix material, the analyses by the two instruments cannot be combined. For example, absolute measurements made by one of the analyzers cannot be used to normalize relative measurements made by the other analyzer. Furthermore, data from the two instruments must be manually processed or transferred to perform the above-described calculations.

### SUMMARY OF THE INVENTION

Embodiments of the present invention provide apparatus and methods for analyzing test samples using complementary techniques, such as XRF and OES, to more completely and accurately determine composition of the test samples, such as including absolute amounts of light and heavy elements in the test materials. Two or more test instruments are registered in relation to a test sample, such that both instruments analyze substantially the same region. The test instruments communicate analytic results between the instruments (or to another component), so that quantitative results of an XRF-measured constituent that is common to both the XRF and OES measurement results (a “linking element”) may be used to interpret relative measurements of the OES instrument into quantitative values.

An embodiment of the present invention provides a method for analyzing composition of a sample. A first instrument, operative to employ an x-ray fluorescence analytical technique, is positioned adjacent a portion of the sample that is to be analyzed. An absolute concentration of a first element in the portion of the sample is measured with the first instrument. The first instrument is removed from the portion of the sample. A second instrument, different than the first instrument and operative to employ an optical spectroscopic analytical technique, is positioned adjacent the portion of the sample. A concentration of a second element, relative to the first element, in the portion of the sample is measured with the second instrument. Information about one of the measured concentrations is sent from one of the first and second instruments to the other of the instruments. An absolute concentration of the second element is calculated in the other instrument, based on the measured absolute concentration of the first element and on the measured concentration of the second element, relative to the first element.

The information about one of the measured concentrations may be sent from one of the instruments to the other of the instruments via a wired or wireless link, such as a wireless link between the two instruments. The first element may be or may include iron, and the second element may be or may include oxygen.

Another embodiment of the present invention provides a jig for holding an x-ray fluorescence analytical instrument and an optical spectroscopic analytical instrument to facilitate analysis of a sample by different techniques employed by the respective instruments. The jig includes a toggle member, a first receiver and a second receiver. The first receiver may be attached to the toggle member and configured to accept at least a portion of the x-ray fluorescence analytical instrument and releaseably hold the instrument fast. The second receiver may be attached to the toggle member and configured to accept at least a portion of the optical spectroscopic analytical instrument and releaseably hold the instrument fast. The toggle member may be configured to toggle between: (a) maintaining the x-ray fluorescence analytical instrument, accepted in the first receiver, in a fixed position, relative to a portion of the sample, and (b) maintaining the optical spectroscopic analytical instrument, accepted in the second receiver, in the fixed position.

Optionally, the toggle member may include a first receptacle and a second receptacle. The first receptacle may be configured to maintain the at least a portion of the sample adjacent the x-ray fluorescence analytical instrument. The second receptacle may be configured to maintain the at least a portion of the sample adjacent the spectroscopic analytical instrument.

The first receptacle may include a first drawer, and the second receptacle may include a second drawer. The toggle member may define two openings, each opening configured to accept a respective one of the drawers.

The toggle member may include a receptacle configured to hold the at least a portion of the sample and to be movable between a first position and a second position. In the first position, the receptacle may maintain the at least a portion of the sample adjacent the x-ray fluorescence analytical instrument accepted by the first receiver. In the second position, the receptacle may maintain the at least a portion of the sample adjacent the optical spectroscopic analytical instrument accepted by the second receiver.

The receptacle may include a drawer, and the toggle member may define an opening configured to accept the drawer and allow the drawer to be moved between the first and the second positions, without removing the drawer from the opening.

The receptacle may include a drawer, and the toggle member may define at least first and second openings. The first opening may be configured to accept the drawer into the first position, and the second opening may be configured to accept the drawer into the second position.

The toggle member may include a chassis and a carriage. The chassis and the carriage may be configured, such that the carriage is moveable, relative to the chassis, between a first position and a second position. The chassis and the carriage may be further configured, such that first and second receivers move in concert with the carriage, such that, in the first position, the x-ray fluorescence analytical instrument accepted by the first receiver is maintained in the fixed position, relative to the portion of the sample, and, in the second position, the optical spectroscopic analytical instrument accepted by the second receiver is maintained in the fixed position.

Optionally, the jig may include a plurality of legs attached to the chassis. An effective length of at least one of the plurality of legs may be adjustable. At least one of the legs may include a clamp or a magnet at one of its ends.

Yet another embodiment of the present invention provides an analyzer for analyzing composition of a sample. The analyzer includes an exciter, a detector, a communication port, a processor and a battery powering the exciter and the processor. The exciter is configured to excite at least a portion of the sample. The excitation produces a response signal from the sample. The detector receives the response signal and produces an output signal. The processor is coupled to the detector and the communication port. The processor is programmed to process the output signal from the detector and determine therefrom a concentration of at least one constituent of the sample. The processor is also programmed to send, via the communication port, information about the determined concentration to another test instrument.

An embodiment of the present invention provides an analyzer for analyzing composition of a sample. The analyzer includes an exciter, a detector, a communication port, a processor and a battery powering the exciter and the processor. The exciter is configured to excite at least a portion of the sample. The excitation produces a response signal from the sample. The detector receives the response signal and produces an output signal. The processor is coupled to the detector and to the communication port. The processor is programmed to receive from another analyzer, via the communication port, information about a determined concentration of a first constituent of the sample. The processor is also programmed to process the output signal from the detector and determine therefrom a concentration of a second constituent of the sample. The processor is also programmed to determine an absolute concentration of one of the constituents, based on an absolute concentration of the other constituent and on a concentration of the one constituent, relative to the other constituent.

Optionally, the analyzer includes a display screen coupled to the processor, and the processor is further programmed to display information about the sample, based on the determined absolute concentration of the one constituent, on the display screen.

An embodiment of the present invention provides a system for analyzing composition of a sample by an x-ray fluorescence (XRF) analytical instrument and an optical emission spectroscopic (OES) analytical instrument utilizing different analytical techniques employed by the respective instruments. The system includes a jig and a receptacle. The jig may be configured to accept, one at a time, in a common receiver, at least a portion of the XRF instrument and at least a portion of the OES instrument and releaseably hold the accepted instrument fast. The receptacle may be configured to maintain at least a portion of the sample adjacent the accepted analytical instrument.

Optionally, the system includes one or more adapters. One adapter may be configured to accept the XRF instrument and to be accepted by the common receiver. The other adapter may be configured to accept the OES instrument and to be accepted by the common receiver.

Another embodiment of the present invention provides a method for operating a plurality of distinct test instruments, each of the test instruments being capable of analyzing composition of a sample. One of the test instruments may be used to analyze the composition of the sample. The analysis may disclose a first relative amount of the sample that contains at least one determined element and a second relative amount of the sample that contains at least one undetermined element. At least some results of the analysis may be transmitted from one of the test instruments to the other test instrument. The other test instrument may be used to analyze the composition of the sample. The analysis may disclose composition of the second relative amount of the sample.

Optionally, one of the test instruments may be an X-Ray fluorescence (XRF) instrument and the other of the test instruments may be an optical emission spectroscopic (OES) instrument. Optionally, one of the test instruments may be calibrated with results of the analysis from the other test instrument.

Yet another embodiment of the present invention provides a computer program product for use on a computer for analyzing composition of a sample. The computer program product may include a tangible computer-readable medium on which are stored computer instructions. When the computer instructions are executed by a processor, the instructions may cause the processor to receive, from another analyzer, information about a concentration of a first constituent of the sample determined by the other analyzer. The instructions may also cause the processor to process an output signal from a detector and determine therefrom a concentration of a second constituent of the sample. The instructions may also cause the processor to determine an absolute concentration of one of the constituents, based on an absolute concentration of the other constituent and on a concentration of the one constituent, relative to the other constituent.

### BRIEF DESCRIPTION OF THE DRAWINGS

The invention will be more fully understood by referring to the following Detailed Description of Specific Embodiments in conjunction with the Drawings, of which:

FIG. 1 is a perspective view of a hand-held XRF test instrument, according to an embodiment of the present invention;

FIG. 2 is a schematic block diagram of the XRF test instrument of FIG. 1, according to an embodiment of the present invention;

FIG. 3 is a perspective view of an OES test instrument, according to an embodiment of the present invention;

FIG. 4 is a schematic block diagram of the OES test instrument of FIG. 3, according to an embodiment of the present invention;

FIG. 5 is a perspective view of a jig for registering two test instruments, relative to a test sample, according to an embodiment of the present invention;

FIG. 6 is a perspective view of the jig of FIG. 5, with the two test instruments accepted into receivers, according to an embodiment of the present invention;

FIG. 7 is a schematic diagram that illustrates sending information about a measured concentration between two test instruments, according to one embodiment of the present invention;

FIG. 8 is a perspective view of a jig for registering two test instruments, relative to a test sample, according to another embodiment of the present invention;

FIG. 9 is a perspective view of a jig for registering two test instruments, relative to a test sample, according to another embodiment of the present invention;

FIG. 10 is a perspective view of a jig for registering two test instruments, relative to a test sample, according to another embodiment of the present invention;

FIG. 11 is a perspective view of the jig of FIG. 10, with a chassis and a carriage assembled and with test instruments accepted by receivers, according to an embodiment of the present invention;

FIG. 12 is a perspective view of three exemplary alternative or optional feet for the jig of FIGS. 10 and 11, according to embodiments of the present invention;

FIG. 13 is a schematic diagram depicting a mode of analyzing a sample, according to an embodiment of the present invention;

FIG. 14 is a flowchart that summarizes operations performed to determine an absolute concentration of an element, according to an embodiment of the present invention; and

FIG. 15 is a perspective close-up view of a snout of an XRF instrument that is equipped with a camera, according to an embodiment of the present invention.

### DETAILED DESCRIPTION OF SPECIFIC EMBODIMENTS

In accordance with the present invention, methods and apparatus are disclosed for analyzing a test sample using complementary techniques, such as XRF and OES. Methods and apparatus are disclosed for registering two or more test instruments, in relation to the test sample, such that each of the instruments analyzes substantially the same region as is analyzed by the other instrument(s), and for communicating analytical results between or among the instruments, or between the instruments and another component, to enable one or more of the instruments, or the other component, to combine the results and, thereby, determine the composition of the test sample. Such registration and communication enables, for example, separate XRF and OES instruments to collectively determine the composition of the test sample, such as the absolute amounts of light and heavy elements in the test material.

While the illustrative embodiments described below and depicted in the figures specify the use of an XRF and an OES instrument, it will be recognized that the invention is not limited thereto, and may in fact be extended to any two or more instruments utilizing different analytical techniques to obtain complementary information regarding the elemental composition of the sample to be analyzed. The term “complementary”, as used herein, denotes that the compositional data acquired using one instrument is not wholly duplicative of compositional data acquired using the other instrument, such that the combined compositional data may be used to characterize the test sample more fully than could be achieved using data from one of the instruments. Examples of analytical techniques that may be utilized for implementations of the present invention include (without limitation) mass spectrometry, x-ray photoelectron spectroscopy (XPS), combustion analysis, neutron activation analysis (NAA), x-ray diffraction (XRD), Raman spectroscopy, and infra-red and near infrared spectroscopy.

### Definitions

Jig—a mechanical device for firmly and individually holding one or more analytical instruments, so as to maintain a desired spatial relationship between business ends (measurement apertures) of the instruments, or a selected one of the instruments, and a test sample and, optionally, allowing movement of the instrument(s) and/or the test sample to a location(s) where a second desired spatial relationship between the business ends of the instruments, or the business end of a selected one of the instruments, and the test sample is maintained.

Registering—matching, in position, locations at which two or more test instruments analyze a test sample by positioning the test instruments, one at a time, relative to the test sample or by position or repositioning the test sample, relative to each of the test instruments.

Toggle—to switch between or among at least two alternatives.

Test Instruments

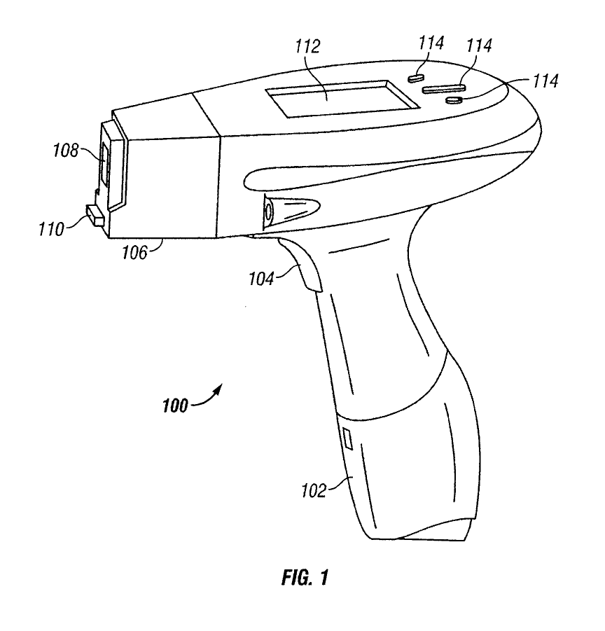

FIG. 1 is a perspective view of a hand-held XRF test instrument 100, similar to the XRF instrument disclosed in the incorporated Provisional Patent Application No. 60/889,465. The XRF instrument 100 includes a miniature x-ray tube (not visible), a (typically rechargeable) battery 102, a trigger 104, a snout 106 defining a window 108, and a safety interlock switch 110 at a front portion of the snout 106. When the snout 106 is pressed against a surface of a test sample (not shown), thereby depressing the interlock 110, and an operator activates the trigger 104, a processor (not visible) activates the x-ray tube. X-rays produced by the x-ray tube exit the snout 106 via the window 108 and illuminate the surface of the test sample.

Fluorescent x-rays from the test sample enter the instrument 100 via the window 108 and are detected by a detector (not visible). Signals from the detector are processed by the processor, and analytical results, such as elemental composition of the sample, may be displayed on a display screen 112. The display screen 112 may include a touch-sensitive screen, by which the operator may interact with the processor. Optionally or in addition, user interface buttons 114 provide an operator interface to the processor. Other structures and functions of the XRF instrument 100, including structures and functions beyond those disclosed in the incorporated provisional patent application, are described below.

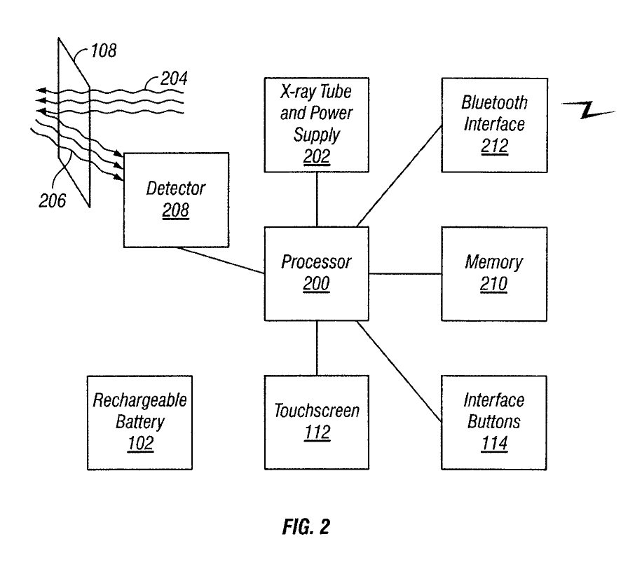

FIG. 2 is a schematic block diagram of the XRF test instrument 100 of FIG. 1. As noted, in use, a processor 200 activates an x-ray source 202, such as an x-ray tube and an associated high-voltage power supply. Produced x-radiation 204 exits the instrument 100 via the window 108 and excites a portion of the test sample (not shown). Fluorescent x-rays 206 from the test sample enter the instrument 100 and impinge on a detector 208.

The processor 200 reads and writes data in a memory 210. The processor 200 also executes instructions stored in the memory 210 to control other portions of the instrument 100 to perform the functions described herein, including processing signals from the detector 208 to determine an absolute concentration of a common element, such as iron, in the test sample. One or more of the first-row transition elements titanium to zinc (Z=22 to 30) may be used as the common element. The processor 200 stores information about the determined concentration in the memory 210.

A wired and/or wireless communication port enables the test instrument 100 to send and/or receive analytical data to and/or from another test instrument or another component. In some embodiments, the communication port includes a Bluetooth wireless interface 212. In other embodiments, the communication port includes another suitable wireless transceiver, such as an infrared (IR), ZigBee or other personal area network (PAN), IEEE 802.11 or proprietary transceiver. In some embodiments, the communication port includes a suitable wired port, such as a fiber optic, universal serial bus (USB), FireWire, serial, parallel or proprietary port.

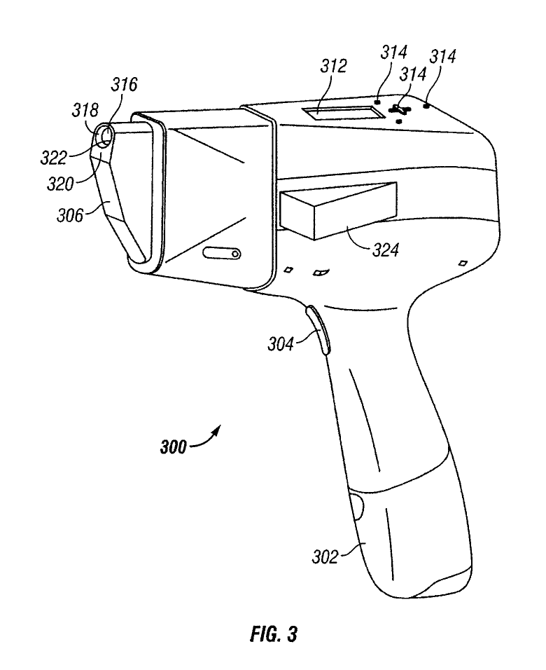

FIG. 3 is a perspective view of an OES test instrument 300, similar to the OES instrument disclosed in the incorporated U.S. Provisional Patent Application No. 60/891,408. The OES test instrument 300 includes many elements that are similar to elements of the XRF test instrument 100 of FIGS. 1 and 2. These similar elements include a rechargeable battery 302, trigger 304, snout 306 (although the OES snout 306 may be shaped differently than the XRF snout 106), display screen 312, user interface buttons 314 and processor (not visible). The OES snout 306 defines a cavity 316, in which a counterelectrode 318 is disposed. A front portion 320 of the snout 306 is flat. The snout 306 is electrically conductive, and the counterelectrode 318 is electrically insulated from the snout 306.

In operation, the flat portion 320 of the conductive snout 306 is pressed against a surface of an electrically conductive test sample (not shown), thereby making an electrical connection between the sample surface and the snout 306 and providing an electrical current return path. Under control of the processor, a spark generator circuit (not visible) generates a voltage between the counterelectrode 318 and the conductive snout 306. A spark and/or arc occurs between the tip of the counterelectrode and the sample surface, thereby exciting a portion of the sample. Optical emissions resulting from the excitation entering the instrument 300 via a window 322 and are routed, possibly by one or more mirrors (not visible) and/or in some applications light pipes, to a spectrometer 324. (Only a portion of the spectrometer 324 is visible in FIG. 3; in other embodiments, the spectrometer 324 may be completely internal to the instrument 300.)

Signals from the spectrometer are processed by the processor, and analytical results, such as composition of the sample, may be displayed on a display screen 312. Other structures and functions of the OES instrument 300, including structures and functions beyond those disclosed in the incorporated provisional patent application, are described below.

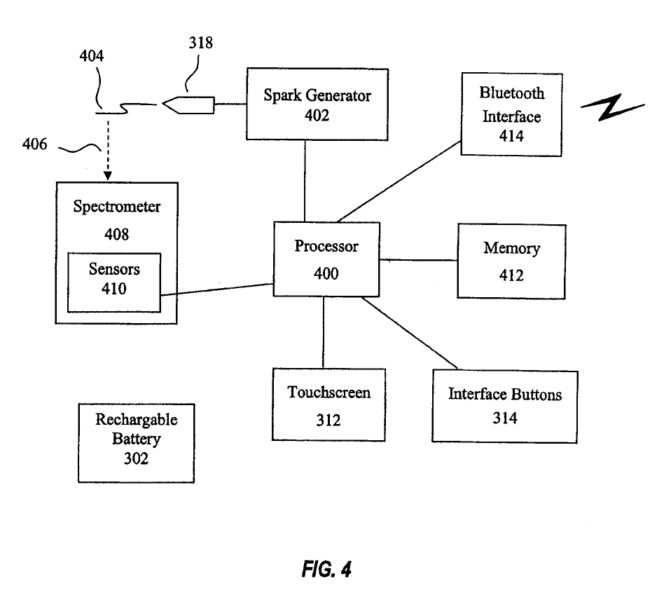

FIG. 4 is a schematic block diagram of the OES test instrument 300 of FIG. 3. As noted, in use, a processor 400 activates a spark generator 402, which powers the counterelectrode 318, and causes a spark/arc 404 between the counterelectrode 318 and the surface of the test sample. Optical emissions 406 resulting from the spark/arc 404 enter the instrument 300 and are routed to a spectrometer 408. In the spectrometer 408, the incoming optical emissions 406 are wavelength dispersed onto a set of sensors 410.

The processor 400 reads and writes data in a memory 412. The processor 400 also executes instructions stored in the memory 412 to control other portions of the instrument 300 to perform the functions described herein, including processing signals from the sensors 410 to determine a concentration of a second element, such as oxygen, relative to the common element in the test sample. The processor 400 stores information about the determined concentration in the memory 412.

A wired and/or wireless communication port enables the test instrument 300 to send and/or receive analytical data to and/or from another test instrument or another component. In some embodiments, the communication port includes a Bluetooth wireless interface 414. In other embodiments, the communication port includes another suitable wireless transceiver, such as an infrared (IR), ZigBee or other personal area network (PAN), IEEE 802.11 or proprietary transceiver. In some embodiments, the communication port includes a suitable wired port, such as a universal serial bus (USB), FireWire, serial, parallel or proprietary port.

### Jig for Complementary Analytical Techniques

If conventional hand-held XRF and OES instruments were used, it would be nearly impossible to take successive measurements with both instruments of substantially the same portion of a test sample (the “analytical site”). That is, it would be nearly impossible to register the two instruments, relative to the analytical site. Without a common analytical site, it is not possible to confidently normalize data from one instrument with data from the other instrument, particularly when analyzing a heterogeneous or matrix test sample. The volume of the test sample that is actually analyzed by each test instrument (or the size of the spot on the surface of the sample, from which fluorescence or emissions are analyzed), together with the homogeneity or granularity of the test sample, determine how accurately the two instruments should be registered on the test sample. The required accuracy is referred to herein as a prescribed “tolerance.”

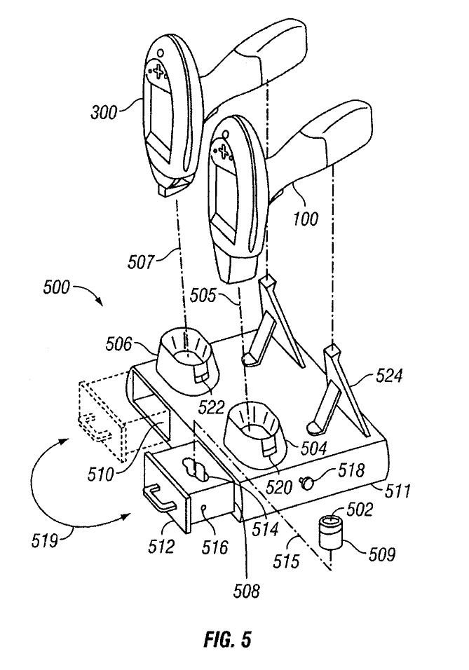

FIG. 5 is a perspective view of a jig 500 for registering two test instruments 100 and 300, relative to a test sample 502, so both test instruments 100 and 300 analyze (typically, at different times) a common analytical site on the test sample 502, within a prescribed tolerance. One of the test instruments 100 may be an XRF test instrument, and the other test instrument 300 may be an OES test instrument. The jig 500 includes two receivers 504 and 506. Each receiver 504 and 506 is configured to accept and releaseably hold a snout of one of the two test instruments 100 and 300, as indicated by lines 505 and 507, respectively. Optionally, the test sample 502 may be stored or held rigidly in a container 509. The jig 500 includes a chassis 511, to which the receivers 504 and 506 are attached.

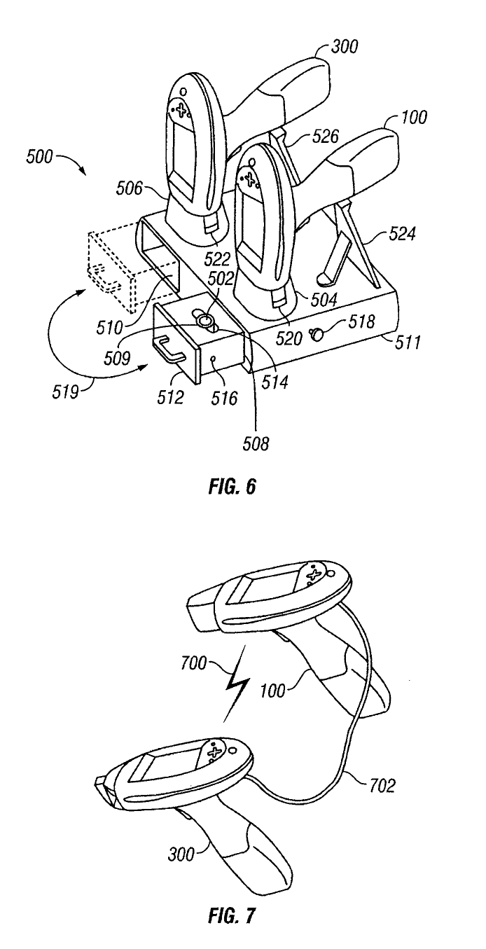

The chassis 511 defines two openings 508 and 510, each opening 508 and 510 being configured to accept a drawer 512. The drawer 512 defines an opening 514, into which the test sample 502 or container 509 may be inserted, as indicated by a line 515. FIG. 6 is a perspective view of the jig 500 with the two test instruments 100 and 300 accepted into the receivers 504 and 506, and the sample 502 and container 509 accepted into the opening 514 in the drawer 512, respectively.

A detent 516 or other mechanical stop on the drawer 512 cooperates with a spring-loaded ball (not visible) in a wall of the opening 508, such that, when the drawer 512 is correctly inserted into the opening 508, the spring-loaded ball engages the detent 516 to hold the drawer 512 positively in a first predetermined position. This engagement can, however, be overcome by a reasonable pulling force on the drawer 512. Thus, the drawer 512 can be inserted into the opening 508, held in the first predetermined position and later easily withdrawn.

The other opening 510 is similarly equipped with another spring-loaded ball (not visible). If the drawer 512 is inserted into the other opening 510 until the other spring-loaded ball engages the detent 516, the drawer 512 is positively held in a second predetermined position. Thus, the drawer 512 may be inserted into either opening 508 or 510, held in either a first or a second predetermined position and later withdrawn. Optionally, the drawer 512 may include one or more additional detents, and the openings may be equipped with other spring-loaded balls, to more securely hold the drawer 512 in the respective predetermined positions. Optionally, the chassis 511 includes a lock (not visible), operable by a knob 518, that firmly holds the drawer in position. In use, once the drawer 512 is inserted into either opening 508 or 510 and is disposed in either the first or the second predetermined position, the lock may be operated to firmly hold the drawer 512 in the position.

The openings 508 and 510, the detent 516 and the spring-loaded balls are located, relative to the receivers 504 and 506, such that, when the drawer 512 is inserted in the first opening 508 and held in the first predetermined position, the sample 502 is oriented within a prescribed tolerance of a test instrument 100 that is, or would be, accepted in the receiver 504. That is, the sample 502 is oriented such that, if a test instrument 100, accepted in the receiver 504, were activated, the test instrument 100 would analyze a predetermined portion of the sample 502. Similarly, when the drawer 512 is inserted in the other opening 510 and held in the second predetermined position, the sample 502 is oriented within the prescribed tolerance of a test instrument 300 that is, or would be, accepted in the other receiver 506. That is, the sample 502 is oriented such that, if a test instrument 300, accepted in the receiver 506, were activated, the test instrument 300 would analyze the same predetermined portion, within the prescribed tolerance, of the sample 502.

The chassis 511, the two openings 508 and 510 and the drawer 512 form all or part of a member that toggles (as indicated by an arrow 519) between: (a) maintaining a snout of one test instrument 100 (such as an x-ray fluorescence analytical instrument), accepted in the first receiver 504, in a fixed position, within a prescribed tolerance, relative to a portion of the sample 502, and (b) maintaining a snout of another test instrument 300 (such as a spectroscopic analytical instrument), accepted in the other receiver 506, in the fixed position, within the prescribed tolerance, relative to the portion of the sample 502.

The prescribed tolerances used with the two test instruments 100 and 300 need not, however, be identical. For example, if one of the test instruments analyzes a larger portion of the test sample 502 than the other test instrument analyzes, the tolerance used with the one instrument may be larger than the tolerance used with the other test instrument.

The snout 106 (not visible in FIG. 5; best seen in FIG. 1) on one of the test instruments 100 may be shaped differently than the snout 306 (not visible in FIG. 5, best seen in FIG. 3) on the other test instrument 300. The interior of each receiver 504 and 506 may be shaped to complement the shape of the snout 106 or 306 that the receiver is to accept. Once the snout 106 or 306 in inserted into the appropriate receiver 504 or 506, the receiver rigidly holds the snout 106 or 306 and, therefore, the test instrument 100 or 300. This hold is sufficient to maintain a test sample-to-test instrument orientation within the prescribed tolerance.

Each receiver 504 and 506 includes a release lever 520 and 522, respectively, or another suitable mechanism that, when actuated, releases the snout 106 or 306 from the receiver 504 or 506. Optionally, the chassis 511 also includes support brackets 524 and 526 to support at least part of the weight of the test instruments 100 and 300, respectively and to prevent or limit movement of the handles of the test instruments.

In use, the test instruments 100 and 300 are accepted by the respective receivers 504 and 506. The drawer 512 with the test sample 502 is inserted into one of the openings 508 or 510, so one of the test instruments 100 or 300 is adjacent a portion of the test sample that is to be analyzed.

If the test instrument is an XRF instrument, an absolute concentration of a first element, such as iron, in the portion of the sample is measured by the test instrument. The XRF instrument may also measure the concentrations of other elements, to which the XRF instrument is sensitive, in the portion of the sample. The XRF instrument may sum the concentrations of determined elements and subtract the sum from 100% to determine a relative amount of the sample that contains at least one undetermined element.

The drawer 512 with the test sample 502 is withdrawn and inserted into the other of the openings 508 or 510, so the other test instrument 100 or 300 is adjacent the same portion of the test sample, within a predetermined tolerance. If the other test instrument is an OES instrument, a concentration of a second element, such as oxygen or carbon, relative to the first element, in the portion of the sample is measured by the test instrument.

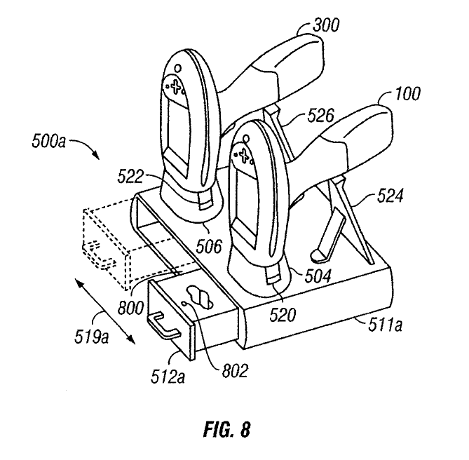

After one of the instruments has completed measuring its concentration, the instrument sends information about the measured concentration to the other instrument or to a separate component. FIG. 7 is a schematic diagram that illustrates sending information about a measured concentration between two test instruments 100 and 300. The test instruments 100 and 300 may establish a wireless link 700, such as a wireless Bluetooth link, and send information about a measured concentration via the wireless link 700. Optionally or alternatively, a cable 702, such as a USB cable, is used to establish a wired link 702 between the two test instruments 100 and 300, and the instruments 100 and 300 send information about a measured concentration via the wired link 702.

Referring again to FIG. 5, in an alternative embodiment, two separate drawers (one of which is shown in phantom) are used, and the sample 502 or the container 509 containing the sample 502 is swapped between the two drawers to implement the toggling action described above. In this case, the chassis 511, the two openings 508 and 510 and the two drawers form all or part of a member that toggles between: (a) maintaining a snout of one test instrument 100 (such as an x-ray fluorescence analytical instrument), accepted in the first receiver 504, in a fixed position, within a prescribed tolerance, relative to a portion of the sample 502, and (b) maintaining a snout of another test instrument 300 (such as a spectroscopic analytical instrument), accepted in the other receiver 506, in the fixed position, within the prescribed tolerance, relative to the portion of the sample 502.

### Sliding Drawer Jig

FIG. 8 is a perspective view of another embodiment of a jig 500a for registering two test instruments 100 and 300, relative to a test sample, so both test instruments 100 and 300 analyze (typically, at different times) a common analytical site on the test sample, within a prescribed tolerance. The jig 500a includes two receivers 504 and 506, as does the jig 500 of FIGS. 5 and 6. However, a chassis 511 a of the jig 500a defines one opening 800, and the drawer 512a may be slid between two predefined positions, as indicated by an arrow 519a, without removing the drawer 512a from the chassis 511a. When the drawer 512a is in a first of the two predefined positions, a sample held by the drawer 512a is adjacent the first test instrument 100, or an instrument that would be accepted by the receiver 504, for analysis thereby and, when the drawer 512a is in a second of the two predefined positions, the sample is adjacent the second test instrument 300, or an instrument that would be accepted by the other receiver 506, for analysis thereby.

Rather than a detent on the side of the drawer (as shown on the drawer 512 in FIGS. 5 and 6), the drawer 512a includes a spring-loaded ball 802 in its top. A detent (not visible) is defined in the ceiling of the opening 800, such that, when the drawer 512a is inserted in the opening 800 and held in the first predetermined position, the sample is oriented within a prescribed tolerance of a test instrument 100 that is, or would be, accepted in the receiver 504. That is, the sample is oriented such that, if a test instrument 100, accepted in the receiver 504, were activated, the test instrument 100 would analyze a predetermined portion of the sample.

Similarly, the ceiling of the opening 800 defines a second detent (not visible), such that, when the drawer 512a is in the opening 800 and held in the second predetermined position, the sample is oriented within a prescribed tolerance of a test instrument 300 that is, or would be, accepted in the receiver 506. That is, the sample is oriented such that, if a test instrument 300, accepted in the receiver 506, were activated, the test instrument 300 would analyze the predetermined portion of the sample.

The ceiling of the opening 800 may also define a groove between the two detents. If present, the groove need not be as deep as the detents. When sliding the drawer 512a between the two predetermined positions, the spring-loaded ball 802 follows the groove. Thus, the groove facilitates sliding the drawer 512a between the two predetermined positions, yet the drawer 512a “snaps” into position at either detent.

### Single Drawer Jig

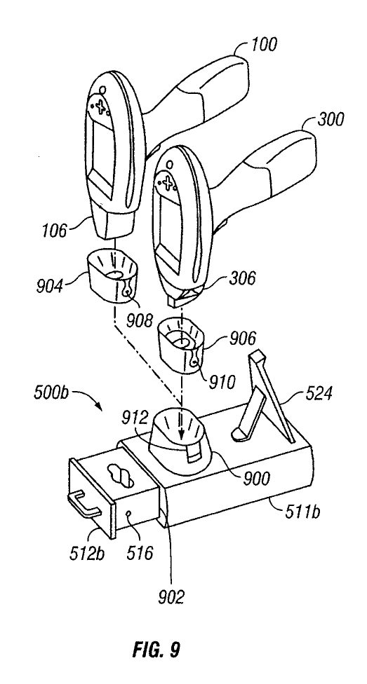

FIG. 9 is a perspective view of another embodiment of a jig 500b for registering two test instruments 100 and 300, relative to a test sample, so both test instruments 100 and 300 analyze (at different times) a common analytical site on the test sample, within a prescribed tolerance. The jig 500b includes one receiver 900, and a chassis 511b of the jig 500b defines one opening 902. The drawer 512b is similar to the drawer 512 shown in FIGS. 5 and 6. A sample is inserted into the drawer 512b, and the drawer 512b is inserted into the opening 902. The test instruments 100 and 300 are inserted, one at a time, into the receiver 900, and the test instruments 100 and 300 analyze, one at a time, the sample. Because the test instruments 100 and 300 are both inserted, one at a time, into a single receiver 900, and because the sample (held in the drawer 512b) does not move between analyses, the two test instruments 100 and 300 analyze identical locations, within a prescribed tolerance, on the sample.

The snout 106 of one of the test instruments 100 may be shaped differently than the snout 306 of the other test instrument 300. If the snout shapes are such that a single receiver 900 can not accommodate one or both shapes, one or more adapters 904 and 906 may be used between one or both of the test instruments 100 and 300 and the receiver 900. In this case, the interior of the adapter 904 may be shaped to complement the shape of the snout 106 of one instrument 100, and the interior of the other adapter 906 may be shaped to complement the shape of the other snout 306 of the other instrument 300. The exteriors of both adapters 904 and 906 are shaped to be accepted by the receiver 900.

Optionally, each adapter 904 and 906 includes a release lever 908 and 910, respectively, or another suitable mechanism that, when actuated, releases the snout 106 or 306 from the adapter 904 or 906. The receiver 900 may include a release lever 912, or another suitable mechanism that, when actuated, releases the adapter 904 or 906. Optionally or alternatively, the drawer 512b may include a detent or spring-loaded ball in the top portion of the drawer 512b, similar to the configuration of the drawer 512a shown in FIG. 8.

### Sliding Carriage Jig

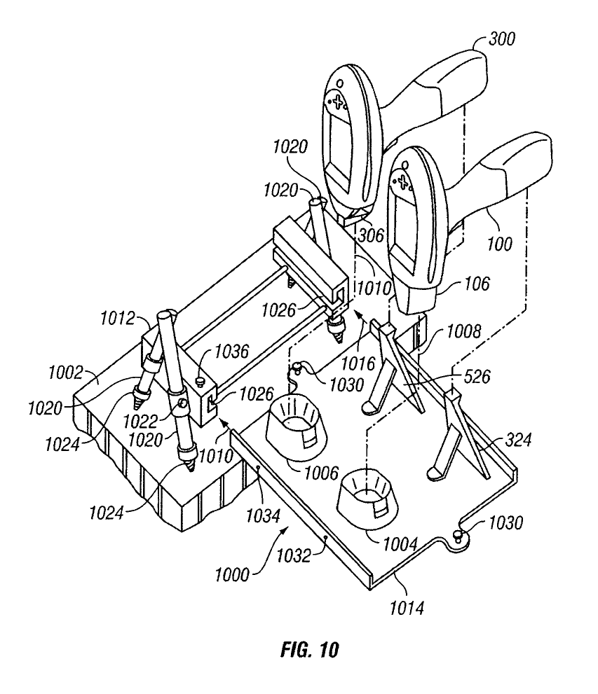

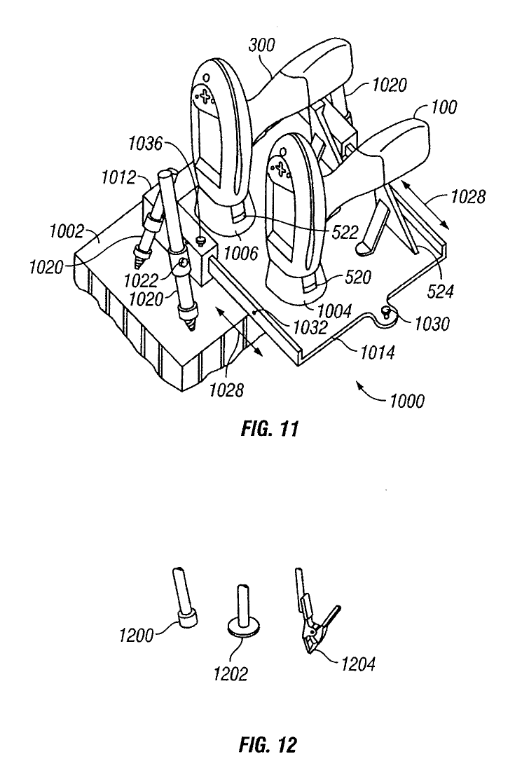

In some cases, a test sample is too large to insert into a container for analysis, or the sample can or should not be moved. Such cases may be accommodated by a jig that may be brought to the sample. FIG. 10 is a perspective view of such a jig 1000, for registering two test instruments 100 and 300, relative to a test sample 1002, so both test instruments 100 and 300 analyze (typically, at different times) a common analytical site on the test sample 1002, within a prescribed tolerance. The jig 1000 includes two receivers 1004 and 1006. Each receiver 1004 and 1006 is configured to accept and releaseably hold a snout of one of the two test instruments 100 and 300, as indicated by lines 1008 and 1010, respectively. The jig 1000 includes a chassis 1012. The jig 1000 also includes a carriage 1014, to which the receivers 1004 and 1006 are attached. The chassis 1012 slideably receives the carriage 1014, as indicated by arrows 1016. FIG. 11 is a perspective view of the jig 1000, with the chassis 1012 and the carriage 1014 assembled, and with the instruments 100 and 300 accepted by the receivers 1004 and 1006.

The chassis 1012 includes adjustable legs 1020, by which the jig 1000 may be stood on, or attached to, the sample 1002. The effective length and/or angle of the legs 1020 may be adjusted by loosening friction screws, one of which is visible at 1022. Replaceable feet 1024 may be selected, based on the material type and/or shape of the sample 1002. The feet 1024 shown in FIG. 10 are pointed. Other exemplary types of feet are shown in FIG. 12, including feet with magnets 1200 at their ends, flat feet 1202 and feet with spring or screw clamps 1204 for attachment to the sample 1002 or another structure. Returning to FIGS. 10 and 11, when the test instruments 100 and 300 are accepted into the receivers 1004 and 1006, respectively, the legs 1020 may be adjusted such that business ends of the test instruments 100 and 300 can be brought into contact with, or as close as necessary to, the surface of the test sample 1002 to conduct required tests.

The chassis 1012 defines a linear track 1026, along which the carriage 1014 may travel, as indicated by an arrow 1028 (FIG. 11). The carriage 1014 includes one or more handles 1030 to facilitate moving the carriage 1014 along the track 1026. The track 1026 includes a spring-loaded ball (not visible) that cooperates (one at a time) with two detents 1032 and 1034 (best seen in FIG. 10) to define two predetermined positions of the carriage 1014 along the track 1026.

The detents 1032 and 1034 and the spring-loaded ball are located, relative to the receivers 1004 and 1006, such that, when the carriage 1014 is in the first predetermined position, the sample 1002 is oriented within a prescribed tolerance of a test instrument 100 that is, or would be, accepted in the receiver 1004. That is, the sample 1002 is oriented such that, if a test instrument 100, accepted in the receiver 1004, were activated, the test instrument 100 would analyze a predetermined portion of the sample 1002. Similarly, when the carriage 1014 is in the second predetermined position, the sample 1002 is oriented within the prescribed tolerance of a test instrument 300 that is, or would be, accepted in the other receiver 1006. That is, the sample 1002 is oriented such that, if a test instrument 300, accepted in the receiver 1006, were activated, the test instrument 300 would analyze the same predetermined portion, within the prescribed tolerance, of the sample 1002.

The chassis 1012 and the carriage 1014 form all or part of a member that toggles (as indicated by the arrow 1028) between: (a) maintaining a snout of one test instrument 100 (such as an x-ray fluorescence analytical instrument), accepted in the first receiver 1004, in a fixed position, within a prescribed tolerance, relative to a portion of the sample 1002, and (b) maintaining a snout of another test instrument 300 (such as a spectroscopic analytical instrument), accepted in the other receiver 1006, in the fixed position, within the prescribed tolerance, relative to the portion of the sample 1002.

The prescribed tolerances used with the two test instruments 100 and 300 need not, however, be identical. For example, if one of the test instruments analyzes a larger portion of the test sample 1002 than the other test instrument analyzes, the tolerance used with the one instrument may be larger than the tolerance used with the other test instrument.

Other aspects of the chassis 1012 and the carriage 1014 are similar to other embodiments described herein. For example, the chassis 1012 may include a lock (not visible), operable by a knob 1036, that firmly holds the carriage 1014 in position, relative to the chassis 1012. Each receiver 1004 and 1006 may include a release lever 520 and 522, respectively, or another suitable mechanism that, when actuated, releases the snout 106 or 306 from the receiver 1004 or 1006. Optionally, the carriage 1015 also includes support brackets 524 and 526 to support at least part of the weight of the test instruments 100 and 300, respectively and to prevent or limit movement of the handles of the test instruments.

### Summary of Operations

As noted, a common element is measured using one analytical technique, such as XRF. For example, for a carbon steel target sample, iron may be measured by the XRF detector. From the measurement, an absolute concentration of the first element is determined. For example, iron might be measured, and a 60% concentration of iron might be found in the test sample.

A measurement is taken using another analytical technique, such as OES (including LIBS), where relative concentrations of second elements of the target sample are determined. The concentrations of the second elements are determined, relative to the first element. For example, the concentration of carbon in the sample may be found to be 1/100 (1%) as high as the concentration of iron in the sample.

The absolute concentration of the second element is determined from the absolute concentration of the first element and from the relative information regarding the first and second elements. For example, if a steel alloy is 60% iron, and there is 1% as much carbon in the alloy as there is iron in the alloy, then alloy is 0.6% carbon. This process is repeated for each of the second elements identified using the second analytical technique. For example, absolute concentration measurements for lighter elements, such as carbon and oxygen, may be determined using the absolute concentration information concerning the common element (here, iron) and the relative information between iron and carbon and between iron and oxygen.

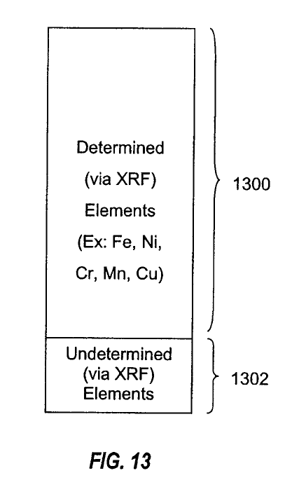

In another mode of operation, schematically represented in FIG. 13, a first analytical technique is used to determine a first fraction 1300 (i.e., a first relative amount) of a sample that contains one or more identifiable elements and a second fraction 1302 (i.e., a second relative amount, typically the remainder) of the sample that contains undetermined elements. For example, XRF analysis may disclose that a sample contains 95.94% determined elements (made up of 72.45% Fe, 21.4% Ni, 1.5% Cr, 0.58% Mn and 0.01% Cu) and 4.06% undetermined elements. Typically, the undetermined elements are light elements that are not detectable by XRF analysis.

A second, different, analytical technique is used to determine the composition of the second fraction 1302 (the 4.06% of the sample in the example above) of the sample. Even if the second analytical technique can not directly determine the absolute concentrations of the elements in the second fraction 1302, the absolute concentrations may be determined indirectly, using information about the elements determined by the first analytical technique and relative concentrations determined by the second analytical technique. Information about the first fraction 1300 and/or information about the second fraction 1302 may be transmitted to the second analytical instrument, to the first analytical instrument and/or to another device for use in the determination.

Continuing the previous example, OES analysis may disclose that the sample contains Fe, C, P, S, and Si. Elements that were detected by both analytical techniques (Fe in this example) may be ignored, because their absolute concentrations were determined by the first analytical technique. The remaining elements detected by the second analytical technique (C, P, S and Si in this example) make up the second fraction 1302 of the sample.

The OES analysis may disclose relative concentrations of the elements in the second fraction 1302. For example, subtracting the elements detected by both analytical techniques (Fe in this example), OES analysis may disclose that C makes up 71.5%, P makes up 0.1%, S makes up 3.5% and Si makes up 24.9% of the undetermined elements 1302. Multiplying each of these relative concentrations by the second fraction 1302 yields the absolute concentration of each of these elements. For example, the absolute concentration in the sample of C is 71.5% times 4.06%, which equals 2.9%, of the whole sample. Similarly, the other absolute concentrations are: P=0.005%, S=0.143% and Si=1.01%. Thus, it may be determined that the sample is an alloyed cast iron, similar to Brammer standard 11X 20001.

Optionally or alternatively, one of the two analytical techniques or instruments may be calibrated using analysis from the other of the analytical techniques or instruments. For example, as noted, XRF technology provides, for the reported elements, quantitative measurement in percent of the total material in the sample. OES measurements, unless calibrated on the type of sample being analyzed, produce only ratio values for the constituents that are reported. Elements that are not reported are not considered quantitatively. Consequently, the percentages reported by the OES measurements typically do not add up to 100%. The use of XRF to establish the quantitative value of a major constituent effectively produces a calibration factor for the sample being measured.

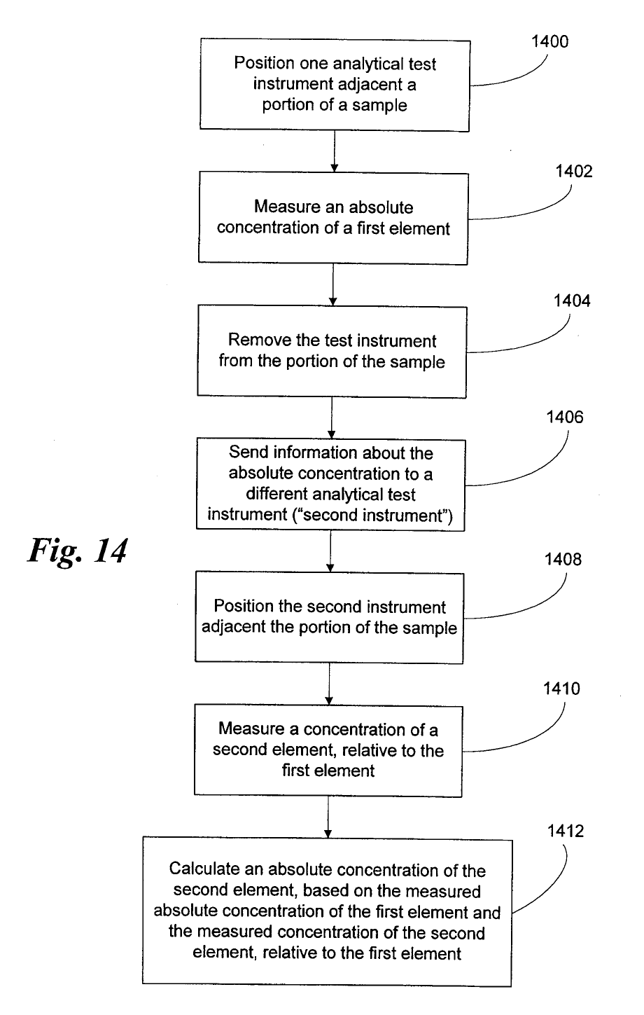

FIG. 14 is a flowchart that summarizes operations performed to determine an absolute concentration of an element, such as a light element, such as carbon or oxygen. At 1400, an analytical test instrument, such as an XRF instrument, is positioned adjacent a portion of a test sample. This may be accomplished by inserting the test sample in a container, inserting the container in a drawer, inserting the drawer in an opening of a chassis and accepting the XRF test instrument, possibly with an appropriate adapter, in a receiver that is adjacent the position of the sample. Alternatively, this may be accomplished by accepting the XRF test instrument in a receiver attached to a carriage that is configured to slide along a track in a chassis, positioning the carriage in a first position, relative to the chassis, and positioning the chassis-carriage combination on the sample.

At 1402, an absolute concentration of a first element, such as iron, is measured by the test instrument. Optionally, a relative amount of the sample that contains one or more elements that can not be detected by the XRF instrument is determined.

At 1406, information about the absolute concentration of the first element is sent to a second, different, analytical test instrument, such as an OES instrument. This may be accomplished by sending the information via a wired or wireless link between the two test instruments. Optionally, information about the relative amount of the sample that contains one or more elements that can not be detected by the XRF instrument is sent to the second analytical test instrument.

After measuring the absolute concentration of the first element, at 1408, the test instrument is removed from the portion of the sample or repositioned. This may be accomplished by removing the drawer from the chassis or by sliding the drawer to a different position within the opening. Alternatively, this may be accomplished by withdrawing the XRF instrument from the receiver, or by sliding the carriage to a different position, relative to the chassis. The second instrument is positioned adjacent the portion of the sample that was analyzed by the first instrument. This may be accomplished by inserting the drawer in a second opening of the chassis or sliding the drawer to a different position within the opening (if the drawer was not moved to this position) and accepting the OES instrument in a second receiver that is adjacent the position of the sample. Alternatively, this may be accomplished by accepting the OES instrument, possibly with an appropriate adapter, in the same receiver as the XRF was previously accepted by, or by sliding the carriage to a different position (if the carriage was not moved to this position) and accepting the OES instrument in a second receiver attached to the carriage and that is adjacent the position of the sample.

At 1410, a concentration of a second element, such as oxygen or carbon, is measured, relative to the first element.

At 1412, an absolute concentration of the second element is calculated, based on the absolute concentration of the first element and on the concentration of the second element, relative to the first element. Optionally or alternatively, composition of the second relative amount of the sample may be determined by the other of the test instruments using information about the relative amount of the sample that contains one or more elements that can not be detected by the XRF. Thus, the compositions of the one or more elements that can not be detected by the XRF instrument are determined. Results of the measurements and/or calculations may be displayed on the test instrument that performed the calculations. Optionally or alternatively, the results of the measurements and/or calculations may be transmitted, such as via the wired or wireless link, to the other test instrument and/or to another device.

Although exemplary embodiments have been described as using XRF and OES (which may include LIPF) instruments, other combinations of analytical instruments may be used in a complementary fashion to measure or calculate a chemical composition of a test sample.

### Camera-Assisted Aiming of Second Test Instrument

Optionally or alternatively, a display screen on the second test instrument and a camera in the snout of the second instrument may be used to assist in aiming the second instrument, so the second instrument tests, within the prescribed tolerance, the same portion of the sample as the first instrument tested. If the first instrument leaves a mark on the sample, the second instrument may display an image produced by the camera on the screen to assist a user in positioning the second instrument, so the second instrument is aimed at the mark. Arc/spark OES (first) instrument may leave a mark on the surface of the sample where the arc/spark struck the sample. Optionally or alternatively, an instrument may include an inkjet, permanent or dry-erase marker, sharp point or other type of marker in the business end of the instrument to mark the sample. Optionally or alternatively, if both instruments are equipped with such cameras, a registration mark may be made, such as by hand, on the surface of the sample, and then the mark may be used to aim both instruments, in succession. Depending on the prescribed tolerance and skill of an operator, it may be possible to aim one or both instruments without the aid of a jig, i.e., one or both instruments may be aimed by hand.

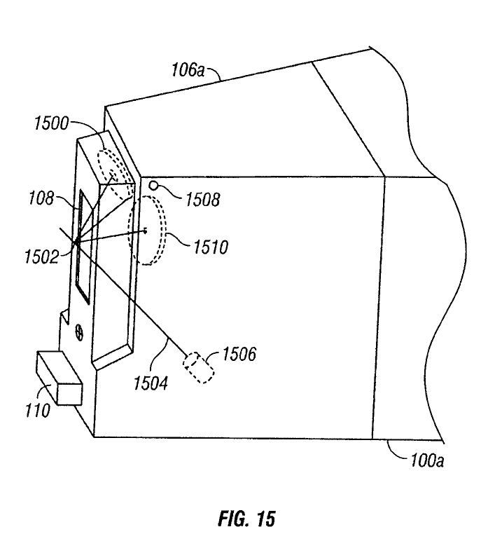

FIG. 15 is a perspective close-up view of the snout 106a of an XRF instrument 100a that is equipped with a camera 1500 that is oriented toward a point 1502, i.e., a portion of a sample that is, or would be, illuminated by an x-ray beam 1504 produced by the x-ray source 1506, as described in the incorporated Provisional Application No. 60/889,465. A light source 1508, such as a laser diode, illuminates the area of the sample surface that is struck by the x-ray beam 1504, thereby making the mark visible to the camera 1500. An x-ray fluorescence detector is shown at 1510.

The camera 1500, together with a an image produced by the camera 1500 and displayed on a display screen similar to the display screen 112 in FIG. 1, facilitates aiming the analyzer, such that the x-ray beam 1504 illuminates a desired portion of the sample. A flattening process may be applied to the image to correct image distortion introduced by the camera's location and aim, relative to the x-ray spot. The processor may be programmed to insert a reticule in the displayed image to indicate the portion of the sample that is, or would be, illuminated by the x-ray beam 1504, i.e., to indicate the size and location of the x-ray spot. Optionally or alternatively, the test instrument may include a laser or other light (not shown) that is oriented to project a visible spot on the sample, or a mechanical indicator, such as a pointer, within the field of view of the camera 1500, in a location that corresponds with the x-ray spot. An OES instrument may be similarly equipped.

Analytical instruments have been described as including processors controlled by instructions stored in memories. Each memory may be random access memory (RAM), read-only memory (ROM), flash memory or any other memory, or combination thereof, suitable for storing control software or other instructions and data. Some of the functions performed by the analytical instruments have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof. Those skilled in the art should also readily appreciate that instructions or programs defining the functions of the present invention may be written in a variety of computer programming languages and delivered to a processor in many forms, including, but not limited to, information permanently stored on non-writable tangible storage media (e.g. read-only memory devices within a computer, such as ROM, or devices readable by a computer I/O attachment, such as CD-ROM or DVD disks), information alterably stored on writable tangible storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. Furthermore, disclosed aspects, or portions of these aspects, may be combined in ways not listed above. Accordingly, the invention should not be viewed as limited to the disclosed embodiments.

What is claimed is:

1. A method for analyzing composition of a sample, the method comprising:
positioning a first instrument, operative to employ a first analytical technique, adjacent a portion of the sample that is to be analyzed and measuring, with the first instrument, an absolute concentration of a first element in the portion of the sample;
removing the first instrument from the portion of the sample;
positioning a second instrument, operative to employ a second analytical technique different than the first analytical technique, adjacent the portion of the sample and measuring, with the second instrument, a concentration of a second element, relative to the first element, in the portion of the sample;
sending information about one of the measured concentrations from one of the first and second instruments to the other of the instruments; and
in the other instrument, calculating an absolute concentration of the second element, based on the measured absolute concentration of the first element and on the measured concentration of the second element, relative to the first element.

2. A method according to claim 1, wherein sending the information comprises sending the information via a wireless link.

3. A method according to claim 1, wherein sending the information comprises sending the information via a wired link between the first and second instruments.

4. A method according to claim 1, wherein the first element comprises iron.

5. A method according to claim 1, wherein the first element comprises iron and the second element comprises oxygen.

6. A method according to claim 1, wherein one of the analytical techniques is x-ray fluorescence.

7. A method according to claim 1, wherein one of the analytical techniques is optical emission spectroscopy.
